(19) United States
(12) Patent Application Publication
(10) Pub. No.: US 2011/0162871 A1
(43) Pub. Date: Jul. 7, 2011

(54) SOLDER MATERIAL COMPRISING A METAL STEARATE AND USE OF METAL STEARATES IN SOLDER MATERIALS

(75) Inventors: Rolf Diehm, Wertheim (DE); Wolfgang Ludeck, Berlin (DE); Andrey Prihodovsky, Bayreuth (DE); Wolfgang Schmitt, Rodgau (DE); Hubert Trageser, Igensdorf (DE); Andreas Fix, Stuttgart (DE); Matthias Hutter, Berlin (DE); Uwe Pape, Berlin (DE); Patrick Zerrer, Weinstadt (DE); Hartmut Meier, Bernau (DE); Bernd Müller, Falkenberg (DE); Ulrich Wittreich, Velten (DE); Dirk Wormuth, Berlin (DE)

(73) Assignee: W.C. HERAEUS GMBH, Hanau (DE)

(21) Appl. No.: 13/001,820

(22) PCT Filed: Jun. 26, 2009
(86) PCT No.: PCT/EP09/58066

§ 371 Date: Mar. 15, 2011

(30) Foreign Application Priority Data
Jun. 30, 2008 (DE) 102008031004.2

(51) Int. Cl. H01B 5/00; B23K 35/363; B23K 1/20

(52) U.S. Cl. 174/126.2; 174/126.1; 148/24; 228/223; 228/224

(57) ABSTRACT

Solder materials, such as a solder paste, and contact surfaces for solder connections are provided in which a metal stearate is used as a flux. The metal stearate is applied either as a solid layer on the solder particles or as contact surfaces or is present as a dispersion or solution in a binder. Advantageously, such materials allow one to avoid the use of classical fluxes. In particular, non-resin solder materials can be provided. A simplified storage and processability of the solder materials results, while at the same time producing comparatively better solder connections. The ability to use metal stearates as a flux is achieved if the first oxide of the metals used is formed from pure metal at lower oxygen activity (aₒ) than the first chromium oxide of chromium, preferably lower than the first titanium oxide of titanium, and if the metal stearate is present in a sufficient amount.

### CROSS-REFERENCE TO RELATED APPLICATIONS

This application is a Section 371 of International Application No. PCT/EP2009/058066, filed Jun. 26, 2009, which was published in the German language on Jan. 7, 2010, under International Publication No. WO 2010/000679 A1 and the disclosure of which is incorporated herein by reference.

### BACKGROUND OF THE INVENTION

The invention relates to various solder materials, which also contain metal stearates. The invention, in particular, relates to solder powder or solder pastes, comprising particles of a solder material, which have a layer of solid metal stearate on the surface, wherein the solder pastes additionally contain a binder surrounding the solder particles. In addition, the invention relates to a solder paste comprising, in general, particles of a solder material and a binder surrounding the particles. Furthermore, the invention relates to solder materials in the form of semi-finished solder products, such as solder wires and solder preforms. Additionally, the invention relates to structural support parts having contact surfaces for electrical components, on which solder deposits can also be provided.

A solder powder according to the above-mentioned type is known, for example, from European Patent EP 1 099 507 B1. The solder powder consists of solder particles of a Sn—Zn-based solder material, which have a solid metal stearate on at least one part of their surface, wherein the metal is preferably Cu, Zn, Ag or Bi. To this end the metal stearate is applied to the surface of the solder particles so that improved storage of the solder powder is possible. The particles of the solder powder, in particular, should be prevented from coming into contact with the activating components of the flux, which is likewise provided in the corresponding solder material, to improve the shelf life of the solder powder. According to EP 1 099 507 B1, all conventional fluxes can be used as flux in the solder material without any special limitation. Included among these are natural resins, such as pine resin, activators and solvents. In addition, substances and tensides influencing the thixotropy are typically contained in the flux. More detailed information about the fluxes to be used is provided in paragraphs 0046 to 0049 of EP 1 099 507 B1.

From Seishi Kumamoto et al., “Joint Strength and Microstructure for Sn—Ag—(Cu) Soldering on an Electroless Ni—Au Surface Finish by Using a Flux Containing a Cu Compound,” Journal of Electronic Materials, Vol. 37, No. 6, pages 806 to 814 (2008), it is additionally known for a copper stearate to be added to the flux, wherein this copper stearate is said to be responsible for the improved stability of the soldered joints formed. This is attributed to the action of the Cu-stearate together with a flux.

### BRIEF SUMMARY OF THE INVENTION

The object of the invention is to provide solder materials, such as solder powder, solder pastes, semi-finished solder products, or structural support parts/components prepared for soldering with and without solder material, in which a flux is used, which is subjected to comparatively few quality fluctuations and can be stored and processed in a comparatively unproblematic manner.

According to the invention, this object is achieved using the various above-mentioned solder materials in the following manner: certain metal stearates are provided as flux, either as a layer on the solder material (solder particles, semi-finished solder product) or on contact surfaces, in an amount of at least 20 wt. %, preferably at least 40 wt. %, of the total metal stearate forming the layer. The certain metal stearate is made of at least one metal, whose first oxide forms from pure metal at a lower oxygen activity than the first chromium oxide of chromium, preferably than the first titanium oxide of titanium. Alternatively, the object is achieved using certain metal stearates contained in the binder, which surrounds the particles of solder material in the solder paste and is contained as flux, in an amount of at least 10 wt. %, preferably at least 20 wt. %, of the binder. The certain metal stearate is made of at least one metal, whose first oxide forms from pure metal at a lower oxygen activity than the first chromium oxide of chromium, preferably than the first titanium oxide of titanium. Furthermore, in this alternative of the invention a dispersant for the metal stearate is contained in the binder, in an amount of up to 50 wt. %. The remainder of the binder is made of other metal salts and/or up to 10 wt. % carboxylic acids and/or activators. The other metal salts, i.e. metal salts, which are not metal stearates, are added to the binder to influence the structure of the soldered joint to be formed or the formation of its boundary surface. For example, diethylamine hydrochloride can be added as an activator.

As dispersants, glycol ether, multivalent alcohols and esters are considered as examples. In this case, these are substances which, because of a relatively strong polarity, render the metal stearate insoluble in them. As the metal stearate is not dissolved, solid metal stearate can be used according to the invention. The use of the metal stearate as flux according to the invention has the advantage that the metal ions, which should assume the function of the flux, are only released by melting the solid metal stearate and remove residues, impurities and especially oxides from the surface of the solder particles and contact surfaces of the joining partners shortly before the formation of the soldered joint due to their reactivity. In this case, the fact is utilized that the melting point of stearates lies below the melting point of the solder alloys used, so that on formation of the soldered joint by melting the solder material the metal ions used as flux are provided only a short time before. On the other hand, the metal ions are advantageously not yet present during storage of the product provided with the flux according to the present invention, thus ensuring long term stability of the solder product. The object of enabling problem-free storage and at the same time guaranteeing minor fluctuations in quality for the finished soldered joints is thus achieved.

According to the invention, the metal stearate is present as a solid. This means that it is not dissolved in the form of ions. Therefore, dispersants for the metal stearate are used for the manufacture of the products with the flux according to the present invention. The metal stearates may be present permanently undissolved in these products. Due to the size of the molecules, the metal stearate can be processed molecularly or in the form of larger crystalline or amorphous agglomerates of molecules. Likewise, the metal stearates form a solid on the substrate, which can be amorphous or crystalline, when they are used as a layer.

Apart from the metal stearate itself, a certain amount of auxiliary materials can also be present in the layer, for example thixotropic agents or residues of the dispersant, with the help of which the metal stearate was applied to the surface of the products according to the invention (for example solder balls) in a previous manufacturing step. This possibly does not completely vaporize, whereby an amorphous metal stearate layer has already formed.

The use of resins in the binder can advantageously also be completely dispensed with. The tree resins (rosin), which in normal fluxes should protect the solder particle surfaces in the solder paste from oxidation and which influence the adhesiveness and the viscosity and thus the flow behavior of the solder paste, are subject to severe quality fluctuations depending on both the market and production area. For this reason, a consistent behavior of the solder pastes used cannot be achieved. To control the quality fluctuations, the properties must be adjusted batchwise using further chemical materials. This effort is advantageously not required when no natural resins have to be used in the binder, thus simplifying the use of the manufactured solder pastes and advantageously improving the quality standard. A further advantage is that the solder pastes can be more easily stored over a longer period of time.

In the case of the use of the metal stearates as a solid layer on the solder material or on the contact surfaces for soldered joints, the advantage is that the solid metal stearate protects the solder material from oxidation in a known way (cf. EP 1 099 507 B1). In addition, however, the advantageous effect is achieved that the certain metal stearates used according to the invention, which in the layer account for a fraction of more than 20 wt. %, preferably a fraction of more than 40 wt. %, of the total amount of metal stearate used, can also assume further functions of the flux, so that conventional flux can be completely omitted. In particular, the main task of the flux, i.e., to cause a cleaning of the surface of the solder particles and of the contact surfaces during the soldering process, can be adopted by the certain metal stearates used according to the present invention as a reactive component.

However, for this purpose it is necessary that the certain metal stearates used according to the present invention be made of at least one metal, whose first oxide forms from pure metal at a lower oxygen activity than the first chromium oxide of chromium, preferably than the first titanium oxide of titanium. In other words, the certain metal stearates must be made of at least one metal towards which oxygen has a thermodynamic activity which at most corresponds to that towards chromium, preferably at most to that towards titanium. For the certain metal stearates used to develop their reactivity as a flux, the thermodynamic activity of oxygen towards the metals used is, in this context, considered to be the decisive criterion. This can be explained by the fact that the metal ions formed by melting of the certain metal stearate during the soldering process develop the required reducing activity as flux.

The thermodynamic activity of oxygen (also known as oxygen activity aₒ) towards different metals can be calculated, where the theoretical foundations for this are cited, for example, in O. Kubaschewski et al., “Materials Thermochemistry,” 6th edition, Oxford (1993). In this case, the equilibrium reaction between the metal concerned and its first metal oxide forms the basis. The first metal oxide is the metal oxide that is formed as the first one in the equilibrium reaction on raising the oxygen partial pressure. For the equilibrium reaction concerned, the so-called Gibbs energy can be found in the literature. From the calculation formula of the Gibbs energy according to Kubaschewski, the temperature-dependent oxygen activity can then be calculated, if reaction conditions are assumed, for which the activities of the metal and the metal oxide amount to exactly the reference value 1. In this way, it can be determined for each metal whether it can be used in the certain metal stearate according to the invention. In other words oxygen, with regard to the equilibrium reaction with the first metal oxide of this metal, has a thermodynamic activity which corresponds at most to that of chromium, preferably at most to that of titanium.

In the case of solid metal stearates, it is also to be mentioned that these are present already in the molten state due to the temperatures prevailing during the soldering process, i.e. that metal ions are available.

By adding the certain metal stearate, e.g. aluminum stearate, to the solder material, reliable soldered joints can be produced in all soldering processes even without the addition of classical flux. The addition of the metal salt thereby takes place either by enriching the solder material, i.e. applying solid metal stearate to the solder material, adding metal stearates to the binder of a solder material or by fabricating the joining partner to be soldered before manufacturing the soldered joint in the manufacturing process. Doing this, solid metal stearate can be applied for example to the contact surfaces of the components or the structural support part, or the structural support part already has on the contact surfaces solder deposits made of a solder material, which are coated with the solid metal stearate. Furthermore, it is also possible to coat semi-finished products made of solder material, as for example a solder wire or solder compacts for ball grid arrays, such as solder balls, with the solid metal stearate. One process, by which such a coating can be performed, is cited in EP 1 099 507 B1. This can occur, for example, by inserting the solder material or the contact surfaces into an oversaturated solution of the metal stearate concerned, which is then deposited onto the surfaces concerned. Another possibility involves spraying the metal stearate in the molten state.

By using the certain metal stearates of the invention and the substitution of classical flux systems by this substance, many problems in the manufacture of fluxes and the transport and storage of the manufactured solder pastes are omitted. Furthermore, restrictions associated with the application, processing and residue removal of the flux may be omitted. Additionally, metal stearates can be manufactured at little cost and can be handled in an environmentally friendly manner with easy disposal, since they contain no toxic substances (at least when the metals of the metal stearates as such are also non-toxic). The metal stearates in addition show no corrosive effect on the soldered joints formed and therefore do not have to be removed after soldering has been effected. Furthermore, the soldered joints are of qualitatively higher value and thus more reliable, thus facilitating manufacture of reliable electronic products.

In addition, the invention relates to the use of a metal stearate as flux for soldering.

As already stated at the onset, the use of metal stearates in solder materials is already known in EP 1 099 507 B1 and in the cited scientific publication by Seishi Kumamoto. However, the metal stearates in connection with these publications are used in addition to the substances known generally as flux. The object of the use of the metal stearates according to the invention lies in an improvement in the long-term stability of the soldered joints formed and in an improvement in the storage stability of the solder pastes produced. The use of a metal stearate as flux, in which the main object of fluxes is also guaranteed, i.e., reducing particles made of solder material during formation of the soldered joint, is based on the surprising discovery that, on suitable selection of metals of the metal stearates used, a reducing action of the metal ions liberated by the metal stearate may adopt this main object of the flux. Because of this, such metal stearates can be used instead of the flux used hitherto, thereby avoiding the above-mentioned problems related to the use of commercial flux.

In an embodiment of the use according to the present invention, it is intended that the metal stearate is used as a single active compound during soldering. Active compounds for the purpose of the invention are understood to mean the compounds that generate a reducing action on the surface of the solder material and the contact surfaces during soldering and thus destroy potential oxide layers which would prevent reliable formation of the soldered joint.

Furthermore, the invention also relates to a use of a metal stearate as flux for soldering, in which the metal stearate is introduced into the binder holding the solder particles of the solder material together, wherein at least fatty acids are additionally contained in this binder. In this case, the property of the metal stearates to thicken the binder is advantageously used. Furthermore, if used in dispersed form in the binder, the metal stearates can develop the action required for the use of the metal stearate as flux according to the invention during soldering, i.e., to act in a reducing manner on the surfaces of the solder particles and the contact surfaces.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic representation showing a cross-section through a solder paste as an embodiment of the solder material according to the invention;

FIG. 2 is a schematic perspective view of a further embodiment of the solder material according to the invention in the form of a section of solder wire, which is coated with metal stearate;

FIGS. 3 and 4 are schematic side views of embodiments of a structural support part according to the invention; and

FIG. 5 is a graph showing the thermodynamic activity of oxygen (aO) towards various metals logarithmically as a function of temperature.

In the drawings, the same or corresponding drawing elements are provided in each case with the same reference numerals and are illustrated repeatedly only if there are differences between the individual Figures.

### DETAILED DESCRIPTION OF THE INVENTION

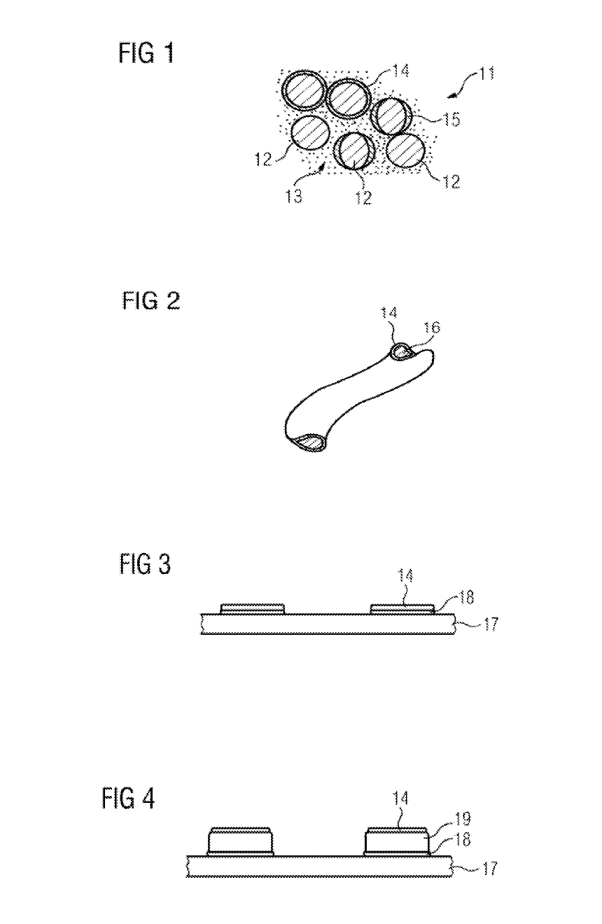

A solder paste 11 according to FIG. 1 is made of particles 12 of a solder material and a binder 13. The solder particles 12 represent in FIG. 1 different embodiments of the invention, wherein variants of the solder paste are also conceivable without loss of generality, where in each case only one type of the different types of particles described hereafter is contained. A first type of particles is completely coated with a layer 14 of metal stearate. This variant has the advantage that the metal stearate is able to prevent oxidation of the particles, thus facilitating problem-free storage of the solder material even over longer periods of time.

A further variant of the particles is only partly coated with metal stearate. In this way islands 15 are produced on the surface, which can be interpreted as a layer and alternate with uncoated parts of the particle. During the soldering process the metal stearate can also develop its reducing action with this variant of the particles.

A third variant of particles 12 of the solder material is uncoated. To guarantee solderability of these particles, it is therefore necessary that either other particles are coated with stearate (as shown in FIG. 1) or that metal stearate is present in the binder (not described in detail). The metal stearate can be present in the binder as a dispersion or in the dissolved state depending on the use of the further materials in the binder that produce either a dispersion or a solution of the metal stearate. Metal stearate can of course also be additionally provided in the binder when using coated particles 12. Thus, a solder paste is provided with which, on the one hand, oxidation of the particles due to a layer 14 located on the surface is effectively prevented and, on the other hand, the viscosity of the binder can be adjusted by the metal stearate used to produce a bonus effect in relation to the intended main action of the metal stearate as reducing agent.

In FIG. 2 a solder wire 16 is shown, which likewise has a layer 14 made of metal stearate. This layer completely surrounds the solder wire to provide protection from oxidation and thus improve the storage stability of the solder wire. Furthermore, the solder wire can be used without the use of an additional flux, simplifying handling during soldering. Instead of the solder wire, other semi-finished solder products can be coated in the same way.

In FIG. 3 a structural support part 17 in the form of a circuit board is schematically shown as a side view. This is provided with contact surfaces 18, which are coated with a layer 14 of metal stearate. Here, protection from oxidation for the contact surfaces is achieved on the one hand and, on the other hand, the metal stearate, which melts during the soldering process, is made available as flux. According to FIG. 4, solder deposits 19 subsequently provided with the layer 14 of metal stearate can also be applied before coating of the contact surfaces 18. Instead of a circuit board, the contact surfaces of components can also be coated with solder deposits and/or metal stearate in the manner described in FIGS. 3 and 4 (not shown).

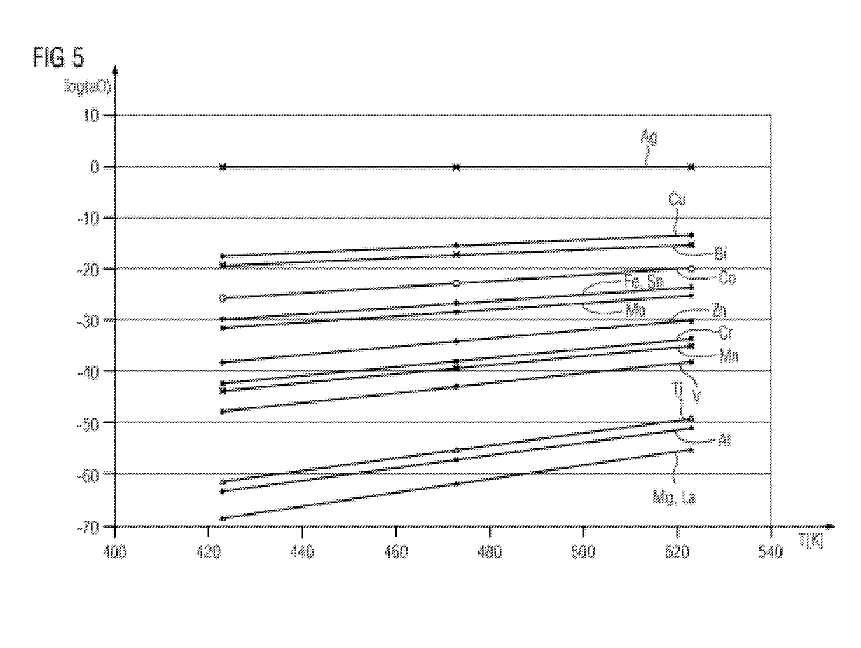

The theoretical background for the selection of the metal stearates according to the invention is described once again using FIG. 5. One of the most important properties of the flux is the ability to reduce the oxides present on the metal particles of the solder material and to protect the metal surfaces liberated in the soldering process from renewed oxidation.

As a general rule the formation of the metal oxide can be described by the following chemical reaction:

xM+yO=MₓO_{y},

where M stands for the metal concerned. In equilibrium, the following applies (see also O. Kubaschewski et al., “Materials Thermochemistry,” 6th edition, Oxford (1993)):

$$Δ {G}^{0} + RT ln \frac{{a}_{{M}_{x} {O}_{y}}}{{a}_{M} {a}_{O}} = 0.$$

ΔG0 is the free standard enthalpy of reaction of this reaction (the temperature-dependent free standard enthalpy of reaction can be calculated on the basis of the known thermodynamic data, either manually or with the aid of thermodynamic programs and databases, such as ThermoCalc, FactSage, etc. and is thus known); a_{MxOy}, a_{M}, a_{O} are the chemical activities of the corresponding metal oxide, metal and oxygen; R is the universal gas constant; and T is the temperature in degrees Kelvin. By using the correct choice of reference conditions, depending on the thermodynamic data used, the activities of the metal and metal oxide are equal to 1. Hence the activity of oxygen in equilibrium with the oxide can be calculated as follows:

$${a}_{O} = exp ( \frac{Δ {G}^{0}}{yRT} ) .$$

In FIG. 5 the activity of oxygen in equilibrium with the metal oxide initially produced is shown for various metals as a function of temperature. The first metal oxide, which is formed from pure metal with increasing oxygen activity, is selected therefrom. As a general rule, this is also the metal oxide whose production is to be suppressed during the soldering process. The diagram was drawn up using the ThermoCalc program and the SSUB database (Pure Substance Database) of the Scientific Group Thermodata Europe (SGTE).

The oxygen activity (aₒ and aO in FIG. 5) calculated by the method described above gives some indication of the reducing action of metal ions of the metal stearate. The reducing action increases as aₒ decreases. Investigations have revealed that the action technically at least necessary for use as flux can be obtained with the metals of the stearate, when aₒ in the above-mentioned equilibrium reaction of the metal with the first metal oxide is at most as high as with chromium (log aₒ at 520 K<−30). Metal stearates are especially effective, which with regard to aₒ correspond at most to the values of titanium, especially aluminum stearate and manganese stearate (log aₒ at 520 K<−48).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-13. (canceled)

14. A solder powder comprising particles of a solder material having a layer of solid metal stearate on a surface of the particles, wherein a certain metal stearate is provided as flux in the layer in an amount of at least 20 wt. %, and wherein the certain metal stearate has as its metal at least one metal whose first oxide forms from the metal in a pure state at a lower oxygen activity (aₒ) than a first chromium oxide of chromium.

15. The solder powder according to claim 14, wherein the certain metal stearate is provided as flux in the layer in an amount of at least 40 wt. %.

16. The solder powder according to claim 14, wherein the certain metal stearate has as its metal at least one metal whose first oxide forms from the metal in a pure state at a lower oxygen activity (aₒ) than a first titanium oxide of titanium.

17. A solder paste comprising particles of a solder material having a layer of solid metal stearate on a surface of the particles and a binder surrounding the particles, wherein a certain metal stearate is provided as flux in the layer in an amount of at least 20 wt. %, and wherein the certain metal stearate has as its metal at least one metal whose first oxide is formed from the metal in a pure state at a lower oxygen activity (aₒ) than a first chromium oxide of chromium.

18. The solder paste according to claim 17, wherein the certain metal stearate is provided as flux in the layer in an amount of at least 40 wt. %.

19. The solder paste according to claim 17, wherein the certain metal stearate has as its metal at least one metal whose first oxide forms from the metal in a pure state at a lower oxygen activity (aₒ) than a first titanium oxide of titanium.

20. A solder paste comprising particles of a solder material and a binder surrounding the particles, wherein a solid metal stearate is contained as flux in the binder, wherein the solid metal stearate comprises an amount of at least 10 wt. % of the binder, wherein the solid metal stearate has as its metal at least one metal whose first oxide is formed from the metal in a pure state at a lower oxygen activity (aₒ) than a first chromium oxide of chromium, and wherein the binder contains a dispersant for the solid metal stearate, the dispersant comprising an amount of up to 50 wt. % of the binder and a remainder of the binder comprising other metal salts and/or up to 10 wt. % carboxylic acids and/or activators.

21. The solder paste according to claim 20, wherein the solid metal stearate comprises an amount of at least 20 wt. % of the binder.

22. The solder paste according to claim 20, wherein the solid metal stearate has as its metal at least one metal whose first oxide is formed from the pure metal at a lower oxygen activity (aₒ) than the first titanium oxide of titanium.

23. The solder paste according to claim 20, wherein the binder is free from resins.

24. A solder material having a form of a semi-finished solder product, wherein the semi-finished solder product has a layer of solid metal stearate, wherein a certain metal stearate is provided as flux in the layer in an amount of at least 20 wt. %, and wherein the certain metal stearate has as its metal at least one metal whose first oxide is formed from the metal in a pure state at a lower oxygen activity (aₒ) than a first chromium oxide of chromium.

25. The solder material according to claim 24, wherein the certain metal stearate is provided as flux in the layer in an amount of at least 40 wt. %.

26. The solder material according to claim 24, wherein the certain metal stearate has as its metal at least one metal whose first oxide forms from the metal in a pure state at a lower oxygen activity (aₒ) than a first titanium oxide of titanium.

27. The solder material according to claim 24, wherein the semi-finished solder product is a solder wire.

28. The solder material according to claim 24, wherein the semi-finished solder product is a solder compact.

29. A structural support part having contact surfaces for electrical components or an electrical component having contact surfaces, wherein the contact surfaces have a layer of solid metal stearate, wherein a certain metal stearate is provided as flux in the layer in an amount of at least 20 wt. %, and wherein the certain metal stearate has as its metal at least one metal whose first oxide is formed from the metal in a pure state at a lower oxygen activity (aₒ) than a first chromium oxide of chromium.

30. The structural support or electrical component according to claim 29, wherein the certain metal stearate is provided as flux in the layer in an amount of at least 40 wt. %.

31. The structural support part or electrical component according to claim 29, wherein the certain metal stearate has as its metal at least one metal whose first oxide is formed from the metal in a pure state at a lower oxygen activity (aₒ) than a first titanium oxide of titanium.

32. A structural support part or electrical component having contact surfaces for a soldered joint, wherein solder deposits are provided on the contact surfaces, wherein a surface of the solder deposits is provided with a layer of solid metal stearate, wherein a certain metal stearate is provided as flux in the layer in an amount of at least 20 wt. %, and wherein the certain metal stearate has as its metal at least one metal whose first oxide is formed from the metal in a pure state at a lower oxygen activity (aₒ) than a first chromium oxide of chromium.

33. The structural support or electrical component according to claim 32, wherein the certain metal stearate is provided as flux in the layer in an amount of at least 40 wt. %.

34. The structural support part or electrical component according to claim 32, wherein the certain metal stearate has as its metal at least one metal whose first oxide is formed from the metal in a pure state at a lower oxygen activity (aₒ) than a first titanium oxide of titanium.

35. The solder powder according to claim 14, wherein the certain metal stearate has as its metal exclusively at least one of the metals selected from the group consisting of aluminum, magnesium, manganese.

36. A method of soldering using a flux, wherein the flux is a metal stearate and wherein the metal stearate is applied to form a solid layer on at least one of the following: solder particles, a semi-finished solder product, solder deposits located on a structural support part or electrical component, and contact surfaces located on a structural support part or electrical component for soldered joints.

37. The method according to claim 36, wherein the metal stearate is used as single active compound during soldering.

38. A method of soldering using a flux, wherein the flux comprises a solid metal wherein a solder material comprises solder particles and a binder, wherein at least fatty acids and the metal stearate are added to the binder, and wherein the binder contains a dispersant for the metal stearate.
